(19) United States
(12) Patent Application Publication
(10) Pub. No.: US 2007/0076995 A1
(43) Pub. Date: Apr. 5, 2007

(54) Ceramic ball bearings

(75) Inventors: David Engel, Springwater, NY (US); Stephen Markle, Holley, NY (US); Anthony C. Kocienski, Rochester, NY (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/546,256

(22) Filed: Oct. 12, 2006

Related U.S. Application Data
(63) Continuation-in-part of application No. 11/413,185, filed on Apr. 28, 2006.
(60) Provisional application No. 60/722,421, filed on Oct. 3, 2005.

(51) Int. Cl. F16C 33/62

(52) U.S. Cl. 384/492

(57) ABSTRACT

A bearing assembly including an inner race having a first groove; an outer race having a second groove; and a plurality of balls disposed between the races and in contact with the races, wherein each groove has a pair of edge corners, and wherein the location of highest load stress between the balls and respective grooves is located away from the corners.

### CROSS-REFERENCE TO RELATED APPLICATIONS

This application is a continuation-in-part of U.S. patent application entitled, MIXING APPARATUS AND METHOD WITH CERAMIC IMPELLER BEARINGS, filed Apr. 28, 2006, having a Ser. No. 11/413,185, now pending, and claims priority to provisional U.S. patent application entitled, MIXING APPARATUS AND METHOD WITH CERAMIC IMPELLER BEARINGS, filed Oct. 3, 2005, having a Ser. No. 60/722,421, the disclosure all of both applications are hereby incorporated by reference in their entirety.

### FIELD OF THE INVENTION

The invention relates generally to rotating bearings, and more particularly to ceramic ball bearings.

### BACKGROUND OF THE INVENTION

Ball bearings are in wide use in industry, for example, in mixing systems. In one example of such a type of mixing system, a vessel is provided that contains a material that is to be mixed, agitated, circulated or suspended. The material has energy imparted to it by rotating impeller blades.

In an example of such a system, the rotating impeller blades extend outwardly and upwardly from a rotating hub that is disposed inside the vessel. The rotating hub is supported by some form of bearing on a shaft that is mounted to protrude inward from an inside surface of the mixing vessel. The hub is subjected to a rotating magnetic field so it is driven by a rotating magnetic drive system that is located on the outside of the vessel. A magnetic field is produced by the magnetic drive system that acts upon the impeller hub, thereby rotating the hub and the impellers.

An example of such a system is described in U.S. Pat. No. 5,758,965 issued to Gambrill et al., and entitled, “Mixer System,” the disclosure of which is hereby incorporated by reference in its entirety.

The system described in U.S. Pat. No. 5,758,965 utilizes various arrangements of bearings for supporting the rotating impeller hub, including bearings having races formed of a metal material (for example, nickel-beryllium alloy). The bearings also have rollable elements (for example, ball bearings) formed of a ceramic (for example, silicon nitride).

Prior systems are also known which utilize metallic races and metallic bearings to support the hub. Systems such as those described above have been very satisfactory. However, there is a continual desire to have bearings with longer life and improved cleanability. The hub bearings are typically “wetted” during mixing. That is, the bearings come in contact with the material being mixed. This can be desirable because the material provides some lubrication to the bearings. However, in some applications the material may be undesirably quite corrosive to metallic parts of the bearings. This corrosion can shorten bearing life.

Due to continually increasing requirements for sterile or highly cleanable mixer operation, for example in the pharmaceutical or biotechnology industries, there is a continuing focus on the cleanability and removeability of mixer impeller systems and associated bearings. Accordingly, it is desirable that the bearings be easily cleaned, for example by spraying a cleaning fluid on them, or by immersion or steam exposure, and that the impeller and bearings be easily removed. Further, there is often a desire that the bearing be capably of “dry running”, that is running without fluid or lubrication on them. There is also a desire to increase the useful life of bearings in all conditions.

The prior art system described in the U.S. Pat. No. 5,758,965, which describes metallic bearing races, has a disadvantage that it has generally been limited to requiring an “angular contact” type of ball bearing in order to provide the service life needed in many applications. FIG. 4 of U.S. Pat. No. 5,758,965 shows such an angular contact type of ball bearing. A disadvantage of the need for an angular contact type of bearing is that when the loads are asymmetrical, (not always acting in one direction), undesirably accelerated bearing wear sometimes occurs.

Therefore, it would also be desirable to have a mixing system that has a durable and cleanable bearing that can also take advantage of the benefits of other configurations of other bearings geometries in addition to angular contact bearings.

It would also be desirable to have a ball bearing structure which is highly durable.

### SUMMARY OF THE INVENTION

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In one aspect, an embodiment of the invention provides a bearing assembly, comprising an inner race having a first groove; an outer race having a second groove; and a plurality of balls disposed between the races and in contact with the races, wherein each groove has a pair of edge corners, and wherein the location of highest load stress between the balls and respective grooves is located away from the corners.

In another aspect, an embodiment of the invention provides a bearing assembly, comprising an inner race having a first groove; an outer race having a second groove; and a plurality of balls disposed between the races and in contact with the races, wherein each groove has a pair of corners, and wherein the circumferential track wrap angle between the corners for each groove is greater than the contact angle.

In one aspect, an embodiment of the invention provides a bearing assembly, comprising an inner race having a first groove; an outer race having a second groove; and a plurality of rolling means disposed between the races and in contact with the races, wherein each groove has a pair of edge corners, and wherein the location of highest load stress between the rolling means and respective grooves is located away from the corners.

In another aspect, an embodiment of the invention provides a bearing assembly, comprising an inner race having a first groove; an outer race having a second groove; and a plurality of rolling means disposed between the races and in contact with the races, wherein each groove has a pair of corners, and wherein the circumferential track wrap angle between the corners for each groove is greater than the contact angle.

In one aspect, an embodiment of the invention provides a method of supporting a shaft with a bearing assembly, comprising disposing a plurality of balls between and in contact with an inner race having a first groove and an outer race having a second groove, wherein each groove has a pair of edge corners, and locating a point of highest load stress between the balls and respective grooves so that the point of highest load stress is located away from the corners.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a layout/cross-sectional view of an impeller, impeller bearings, and impeller drive system according to a preferred embodiment of the present invention.

FIG. 2 is a cross-sectional view of a first embodiment of ceramic deep groove ball bearing assembly with ceramic balls and ceramic races.

FIG. 3 is a side view of a second embodiment of a ceramic deep groove ball bearing assembly with ceramic balls and ceramic races.

FIG. 4 is a cross-sectional view of the second embodiment taken through line 4-4 in FIG. 3.

FIG. 5 is a detailed cross-sectional view of the bearing in FIG. 4.

FIG. 6 is a detailed view of the bearing in FIG. 4.

FIG. 7 is a side view of a third embodiment of a ceramic deep groove ball bearing assembly with ceramic balls and ceramic races.

FIG. 8 is a cross-sectional view of the third embodiment taken through line 7-7 in FIG. 6.

FIG. 9 is a detailed cross-sectional view of the bearing in FIG. 8.

FIG. 10 is a detailed view of the area identified by the circle 8-8 in FIG. 8.

### DETAILED DESCRIPTION

Various embodiments of the present invention provide ball bearings. Some embodiments may be suitable for are in mixers having an impeller hub supported via one or more completely all-ceramic bearings. That is, the bearings have inner and outer races, both of which are made of a ceramic material, and also utilize ceramic rolling elements, for example ceramic balls.

A first embodiment of the present invention provides a ceramic deep groove ball bearing assembly having ceramic inner and outer races and ceramic rolling elements, for example, ceramic balls.

A second embodiment of the present invention provides a ceramic deep groove ball bearing assembly also having ceramic inner and outer races and ceramic rolling elements, for example, ceramic balls.

A third embodiment of the present invention provides a ceramic deep groove ball bearing assembly having ceramic inner and outer races and ceramic rolling elements, for example, ceramic balls, having a deeper groove compared to the second embodiment.

One or more sets of these bearings may be provided, and the bearings may be caged or uncaged. Further, either a full complement or a partial complement of balls may be provided in each set of the races. A benefit to the use of all-ceramic bearings is that the ceramic material permits the use in some embodiments of “deep groove” ball bearing structures in place of partially metallic angular contact bearings.

The ability to use deep groove bearings as an alternative to angular contact bearings in many applications provides better life, particularly in applications where the loads are not always in the same direction during operation.

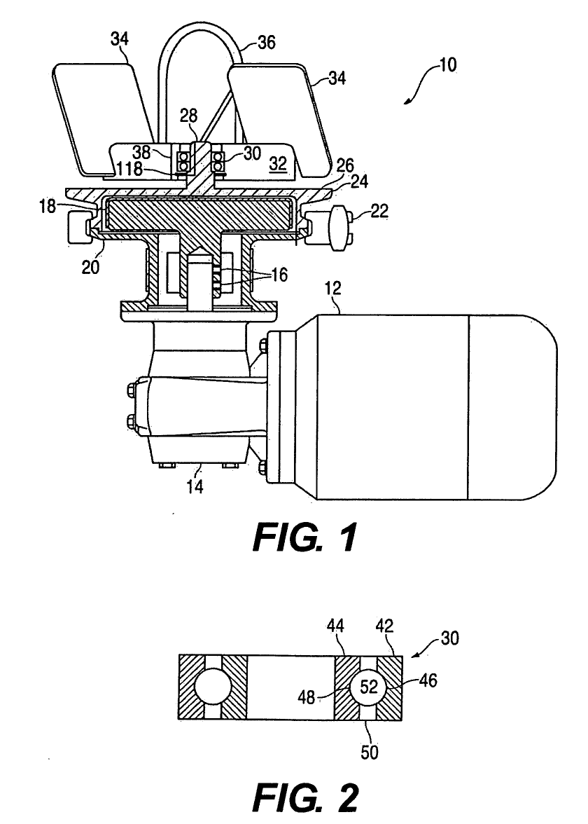

FIG. 1 depicts an impeller and impeller drive system 10 according to a preferred embodiment of the present invention. The system 10 includes a motor 12 which drives a speed reducer 14 connected thereto.

The speed reducer 14 has an output shaft that is connected by one or more set screws 16 to a magnetic drive rotor 18. Thus, it will be appreciated that the magnetic drive rotor 18 is in effect supported by bearings (not shown) which are located in the speed reducer 14. The magnetic drive rotor 18 has either a number of magnets or one large magnet disposed either around or in the drive rotor 18 so that rotation of the magnet drive rotor 18 creates a rotating magnetic field thereabout.

A clamp plate adaptor 20 is provided which is attached to the speed reducer 14 and acts as a pedestal so that a clamp 22 can attach the clamp plate adaptor 20 to a tank plate 24. The tank plate 24 serves as a fixture that can be welded into a similarly size aperture in a tank (or vessel) so that the motor 12, speed reducer 14, and clamp plate adaptor 20 are all located exterior to the tank. The tank plate 24 has an inner surface 26 which will be exposed to the material that is inside the vessel.

Projecting inward into the tank from the inner surface 26 is a stub shaft 28. The stub shaft 28 supports one or more bearing assemblies 30. In the embodiment illustrated in FIG. 1, two bearing assemblies 30 are stacked directly on top of each other. These bearing assemblies 30 are retained by a shoulder on the stub shaft 28 and also by an opposed shoulder on an impeller disk 32.

The impeller disk 32 supports a number of impeller blades 34. A grasping loop 36 may also be provided to facilitate lifting of the impeller for disassembly.

The impeller disk 32 is made of a material that is subject to magnetic fields, such that rotation of the magnetic drive rotor 18 causes a magnetic field that tends to rotate the impeller disk 32, and hence rotate the impeller blades 34. Optionally, flow channels 38 can be provided through the impeller disk 32, which flow channels may be similar to the flow channels in U.S. Pat. No. 5,758,965.

A feature of the invention is the combination of the use of all-ceramic bearings 30 in a magnetic driven impeller system. These all-ceramic bearings 30 may be made of any ceramic (nonmetallic) material, but preferably may be made of for example silicon nitride, or zirconium oxide. The use of all-ceramic bearings 30 avoids the need for any metallic bearing contact elements. This means, in at least some applications, that the bearings 30 can be more resistant to corrosion and/or wear than would be comparable bearings with metal elements.

Another significant advantage of the use of all-ceramic bearings is that the ceramic material permits the use of deep groove ball bearings in place of angular contact bearings, in applications which previously required angular contact bearings. The all-ceramic bearings 30 also provide greater life in some applications than metal bearings.

FIG. 2 is a cross-sectional view of a first preferred embodiment of a ceramic deep groove ball bearing assembly with ceramic balls and ceramic races. FIG. 2 illustrates the bearing 30 having an outer race 42 and an inner race 44. The outer race 42 has a relatively deep groove 46 and the inner race 44 has a relatively deep groove 48. Both of these grooves are symmetrical, the groove has similar depth with respect to both the top and the bottom of the bearing. A channel 50 is formed between the outer race 42 and inner race 44. An exemplary ball bearing element 52 is illustrated.

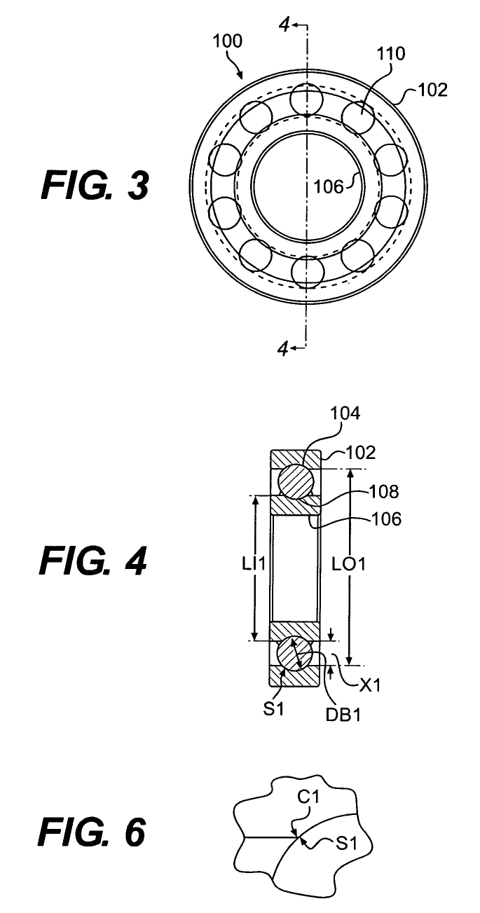

FIGS. 3-5 illustrate a second preferred embodiment of a ceramic ball bearing 100. The bearing 100 includes an outer race 102 having a groove 104. The bearing 100 also includes an inner race 106 having a groove 108. The inner race 106 also has an outer diameter LI 1. The outer race 102 has an inner diameter LO 1. A plurality of balls 110 are disposed between the races 102, 106. The balls 110 have a diameter DB1. FIG. 4 illustrates a space X1 which X1 equals to one-half of the difference between LO 1 and LI 1.

The second embodiment depicts a ratio of LI 1 to L0 1 as well as ratio of DB1 to X1 that is a ratio typically used with all metal bearings.

This design has proven advantageous and effective in many applications. However, it has been noted that the inner and outer races 106, 102 have high stress areas indicated by the letters S1 and S2. In the case of all ceramic construction, including ceramic balls 110 and ceramic races 102 and 106, the ceramic materials which can tend to be brittle will sometimes cause a chipping at the high stress area S1 which then leads to an increasing rough spot, which increases in size until a large fracture is present in this area. In this embodiment, the locations of the highest stress S1 and S2 are near or substantially co-extent with “corners” at the edges of the grooves 104 and 108. The corners are the most susceptible region for rough spots, cracking, fracturing, chipping, or breaking off, of small or large chips or particles. Thus, the corners are somewhat susceptible to wear. This type of wear can be undesirable because it then leads to further wear of the race and also the balls 110.

It is noted here that ceramics can be in some cases more susceptible to such cracking, compared to steel, since the ceramics are more brittle than steel. Thus, for ceramic races and/or ceramic balls, it is often desirable to move the high stress area inward from the corners. In particular, as the high stress area moves towards the corners, the ceramics will tend to chip or calfe off at the corners. Ceramics at the same geometry are more susceptible to this at the same loads compared to metals.

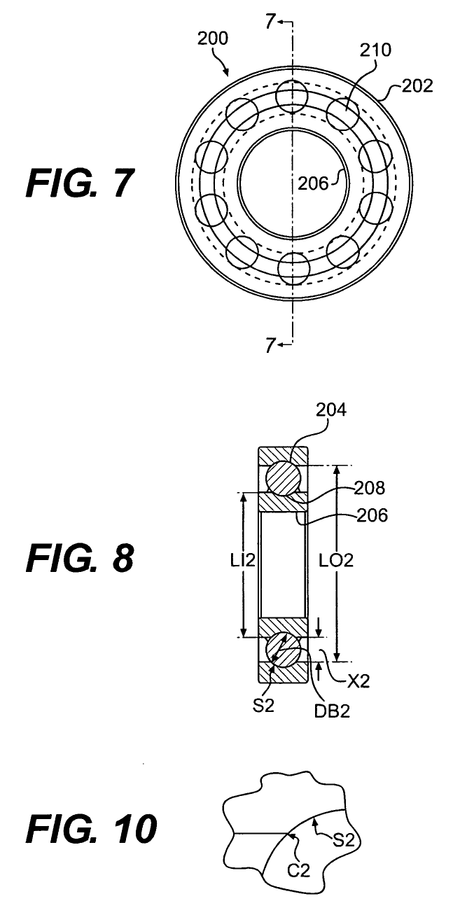

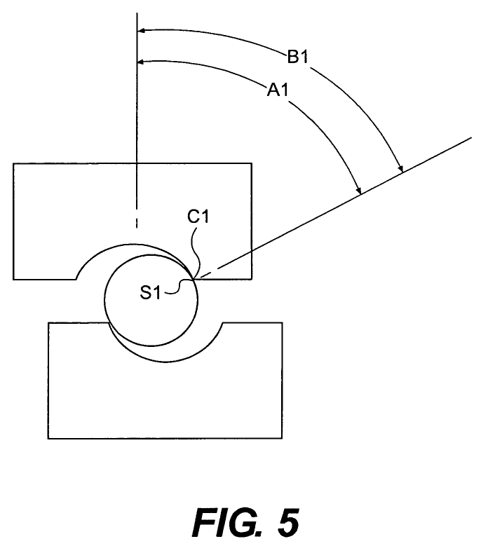

Turning now to FIG. 5 certain aspects of the geometry of the second embodiment are illustrated. In particular, this embodiment has a geometry that would be suitable for metal races, that may be less suitable for ceramic races in some instances. In particular, in this embodiment, the groove is deep, but only so deep that once subjected to a axial load the point of stress S1 is near or substantially co-extent with the corners C1. In this type of geometry, the angle of wrap A1 of the groove is generally the same value as the contact angle B1. This type of geometry is sometimes used for metal races, but is discussed above may at high loads and/or high axial stress lead to chipping or cracking near the corner C1.

With regard to each of the three illustrated embodiments, any ceramic material or materials may be used for each of these components; however, it is noted that silicon nitride and zirconium oxide are examples of suitable materials.

FIG. 6-8 illustrate a third embodiment of an all ceramic ball bearing which includes an outer race 202 having a groove 204 and an inner race 206 having a groove 208. The inner race has an outer diameter LI2 and the outer race 204 has an inner diameter LO2. A plurality of balls 210 are disposed between the races 202 and 206. The balls 210 have a diameter DB2.

In some applications, a benefit of this third embodiment compared to the previous second embodiment is that the highest stress point S2 is located away from the corner of the groove 204 and 208 indicated by location C2. Because the point of highest load and highest stress located at S2 is moved away from the corner C2 of the grooves 204 and 208, this embodiment in some applications may be less susceptible to rough spots, cracking, fracturing, chipping, breaking off or other wear as described with respect to the second embodiment.

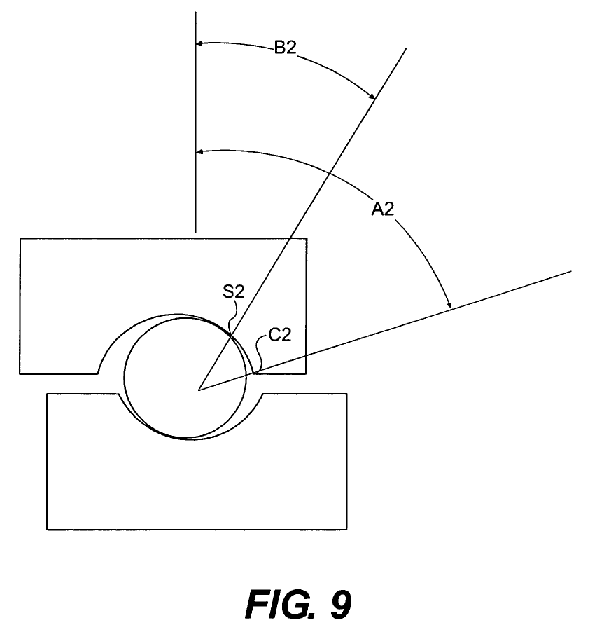

FIG. 9 is a view similar to FIG. 5, but showing a relative geometry of the third embodiment. In this third embodiment, the grooves are deeper than in the second embodiment, and these deep grooves tend to have a greater angle of wrap around the ball then in the second embodiment. Therefore, it would be appreciated that in FIG. 9 the angle of wrap A2 is greater than the angle of wrap in A1 in FIG. 5. Further, in FIG. 9, the angle of wrap A2 is greater than the contact angle B2 of this embodiment. As discussed above, the deeper type of groove, having an angle of wrap greater than the contact angle, it is particularly useful in a case of ceramic bearings.

With regard to all of the drawing figures, and especially FIGS. 5 and 9, it is noted that these drawings are not to scale. To the contrary, some aspects of these drawings may be exaggerated compared to scale in order to allow the relative location such as S1 and C1, as well as the relative angles A1, B1, A2, B2 to be discussed in a relative fashion and readily visualized. However, the actual dimensions and scale and relative values of any of these parameters may be exaggerated in any role of the drawing figures at least to some extent.

In some embodiments, the balls and the races may be made of silicon nitride. In other embodiments, the races may be made of zirconium oxide and the balls made of silicon nitride.

A benefit of this embodiment is that it locates the points of highest stress away from the corner-edges of the grooves in the races, and thereby decreases fracturing, chipping, or breaking off of small or large chips or particles, and wear at these corners, thereby substantially improving bearing life in some instances.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A bearing assembly, comprising:
an inner race having a first groove;
an outer race having a second groove; and
a plurality of balls disposed between the races and in contact with the races, wherein each groove has a pair of edge corners, and wherein the location of highest load stress between the balls and respective grooves is located away from the corners.

2. The assembly according to claim 1, wherein the inner and outer races are ceramic.

3. The assembly according to claim 1, wherein the balls are ceramic.

4. The assembly according to claim 1, wherein the inner race, the outer race, and the balls are ceramic.

5. The assembly according to claim 4, wherein the ceramic is silicon nitride.

6. The assembly according to claim 4, wherein the ceramic is zirconium oxide.

7. A bearing assembly, comprising:
an inner race having a first groove;
an outer race having a second groove; and
a plurality of balls disposed between the races and in contact with the races, wherein each groove has a pair of corners, and wherein the circumferential track wrap angle between the corners for each groove is greater than the contact angle.

8. The assembly according to claim 7, wherein the inner and outer races are ceramic.

9. The assembly according to claim 7, wherein the balls are ceramic.

10. The assembly according to claim 7, wherein the inner race, the outer race, and the balls are ceramic.

11. The assembly according to claim 10, wherein the ceramic is silicon nitride.

12. The assembly according to claim 10, wherein the ceramic is zirconium oxide.

13. A bearing assembly, comprising:
an inner race having a first groove;
an outer race having a second groove; and
a plurality of rolling means disposed between the races and in contact with the races, wherein each groove has a pair of edge corners, and wherein the location of highest load stress between the rolling means and respective grooves is located away from the corners.

14. The assembly according to claim 13, wherein the inner and outer races are ceramic.

15. The assembly according to claim 13, wherein the rolling means are ceramic.

16. The assembly according to claim 13, wherein the inner race, the outer race, and the rolling means are ceramic.

17. The assembly according to claim 16, wherein the ceramic is silicon nitride.

18. The assembly according to claim 16, wherein the ceramic is zirconium oxide.

19. A bearing assembly, comprising:
an inner race having a first groove;
an outer race having a second groove; and
a plurality of rolling means disposed between the races and in contact with the races, wherein each groove has a pair of corners, and wherein the circumferential track wrap angle between the corners for each groove is greater than the contact angle.

20. The assembly according to claim 19, wherein the inner and outer races are ceramic.

21. The assembly according to claim 19, wherein the rolling means are ceramic.

22. The assembly according to claim 19, wherein the inner race, the outer race, and the rolling means are ceramic.

23. The assembly according to claim 22, wherein the ceramic is silicon nitride.

24. The assembly according to claim 22, wherein the ceramic is zirconium oxide.

25. A method of supporting a shaft with a bearing assembly, comprising:
disposing a plurality of balls between and in contact with an inner race having a first groove and an outer race having a second groove, wherein each groove has a pair of edge corners, and
locating a point of highest load stress between the balls and respective grooves so that the point of highest load stress is located away from the corners.
